(19) United States
(12) Patent Application Publication
(10) Pub. No.: US 2019/0037323 A1
(43) Pub. Date: Jan. 31, 2019

(54) TOOL FOR TESTING AUDIO SYSTEMS

(71) Applicant: Harman International Industries, Incorporated, Stamford, CT (US)

(72) Inventors: Jonathan Pierce, Ann Arbor, MI (US); Robert Paul, Royal Oak, MI (US)

(73) Assignee: Harman International Industries, Incorporated, Stamford, CT (US)

(21) Appl. No.: 16/043,560

(22) Filed: Jul. 24, 2018

Related U.S. Application Data
(60) Provisional application No. 62/536,751, filed on Jul. 25, 2017.

(51) Int. Cl. H04R 29/00; H04R 1/08

(52) U.S. Cl. CPC H04R 29/001; H04R 2499/13; H04R 1/08

(57) ABSTRACT

An apparatus for defining an acoustic reference for an audio system on an open air vehicle. The apparatus has a center frame module, a first side frame module extending laterally from a first side of the center frame and adjustable between 0 and 180 degrees with respect to the center frame, a second side frame module extending laterally from a second side of the center frame and adjustable between 0 and 180 degrees, and at least one piece of test equipment mounted to at least one of the center, first side or second side frames thereby defining the acoustic reference.

### TECHNICAL FIELD

The inventive subject matter is directed to a tool for controlled tests and evaluations related to audio systems for open-air vehicles.

### SUMMARY

An apparatus for defining an acoustic reference for an audio system on an open air vehicle. The apparatus has a center frame module, a first side frame module extending laterally from a first side of the center frame and adjustable between 0 and 180 degrees with respect to the center frame, a second side frame module extending laterally from a second side of the center frame and adjustable between 0 and 180 degrees, and at least one piece of test equipment mounted to at least one of the center, first side or second side frames thereby defining the acoustic reference.

A method for evaluating an audio system on an open-air vehicle. The method sets a position of a center frame, adjusts a position of a first side frame that extends laterally from a first side of the center frame, adjusts a position of a second side frame that extends laterally from a second side of the center frame. By positioning a plurality of supports on the center, first side and second side frames to support at least one piece of test equipment an acoustic reference for the audio system is defined. An open-air vehicle is placed on a stand positioned in front of the center frame as data is collected from the at least one piece of test equipment.

### DESCRIPTION OF DRAWINGS

FIG. 1 is a perspective view of one or more embodiments of an acoustic reference tool;

FIG. 2 is a perspective view of a one or more embodiments of an acoustic reference tool;

FIG. 3 is a top view of the acoustic reference tool of FIG. 1;

FIG. 4 is a perspective view of a motorcycle in position for testing using the acoustic reference tool; and

FIG. 5 is a block diagram of a system associated with the acoustic reference tool of FIGS. 1 and 2.

Elements and steps in the figures are illustrated for simplicity and clarity and have not necessarily been rendered according to any particular sequence. For example, steps that may be performed concurrently or in different order are illustrated in the figures to help to improve understanding of one or more embodiments of the inventive subject matter.

### DESCRIPTION OF INVENTION

While various aspects of the inventive subject matter are described with reference to a particular illustrative embodiment, the inventive subject matter is not limited to such embodiments, and additional modifications, applications, and one or more embodiments may be implemented without departing from the inventive subject matter. In the figures, like reference numbers will be used to illustrate the same components. Those skilled in the art will recognize that the various components set forth herein may be altered without varying from the scope of the inventive subject matter.

Any one or more pieces of test equipment, servers, receivers, or devices described herein include computer executable instructions that may be compiled or interpreted from computer programs created using a variety of programming languages and/or technologies. In general, a processor (such as a microprocessor) receives instructions, for example from a memory, a computer-readable medium, or the like, and executes the instructions. A processing unit includes a non-transitory computer-readable storage medium capable of executing instructions of a software program. The computer readable storage medium may be, but is not limited to, an electronic storage device, a magnetic storage device, an optical storage device, an electromagnetic storage device, a semi-conductor storage device, or any suitable combination thereof. Any one or more the devices herein may rely on firmware, which may require updates from time to time to ensure compatibility with operating systems, improvements and additional functionality, security updates or the like. Connecting and networking servers, receivers or devices may include, but are not limited to, SATA, Wi-Fi, lightning, Ethernet, UFS, 5G, etc. One or more servers, receivers, or devices may operate using a dedicated operating system, multiple software programs and/or platforms for interfaces such as graphics, audio, wireless networking, enabling applications, integrating hardware of test equipment, vehicle components, systems, and external devices such as smart phones, tablets, and other systems to name just a few.

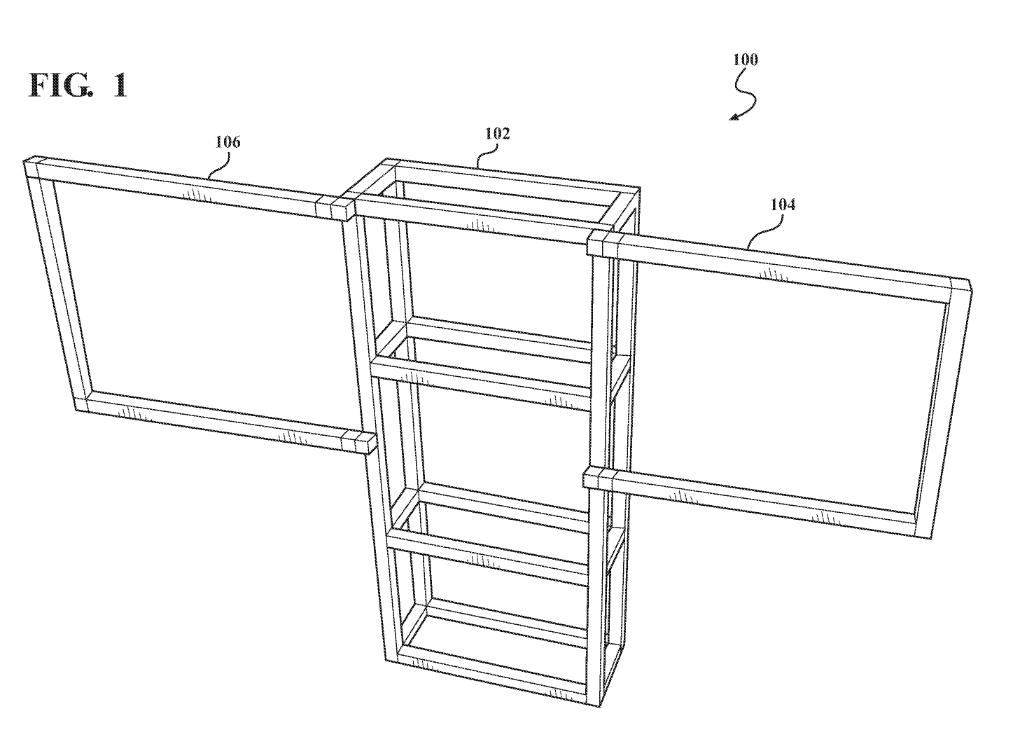

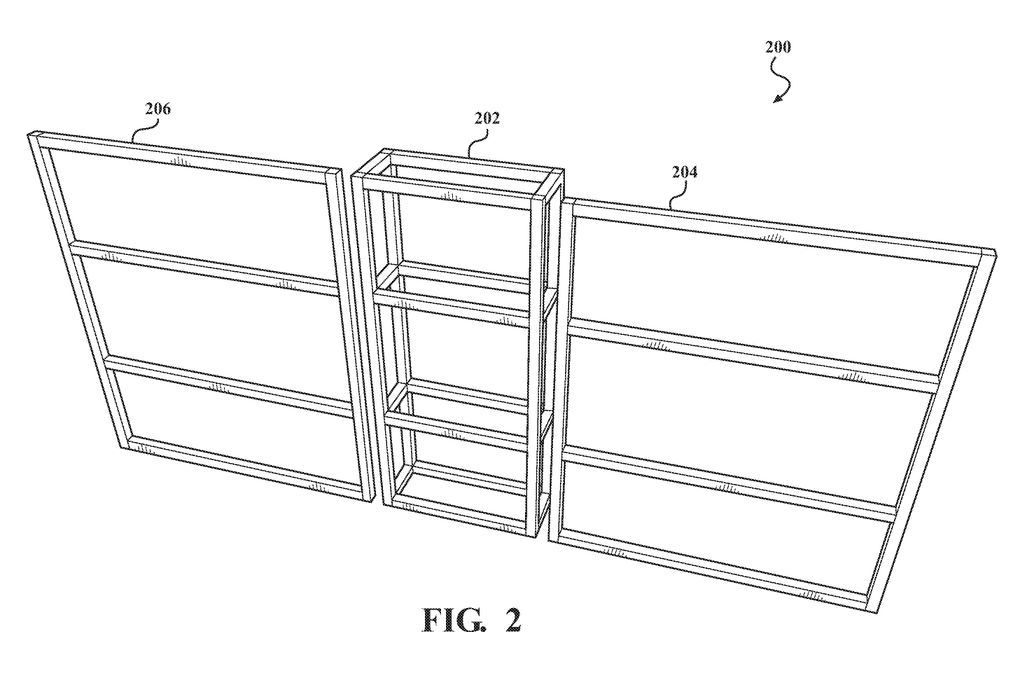

FIG. 1 is a perspective view of a tool 100 that provides an acoustic reference to subjectively evaluate an audio system on an open-air vehicle, such as a motorcycle. The tool 100 has a center frame 102 and two extended sections 104, 106. The extended sections 104, 106 each extend laterally from the center frame 102. The extended sections 104, 106 are located at each side of the center frame 10 and are adjustable from 0 to 180 degrees with respect to the center frame 102. A height of the extended sections 104, 106 may be less than an entire height of the center frame 102 as shown in FIG. 1. In another example 200, the extended sections 204, 206 may extend the entire length of the center frame 202 as shown in FIG. 2.

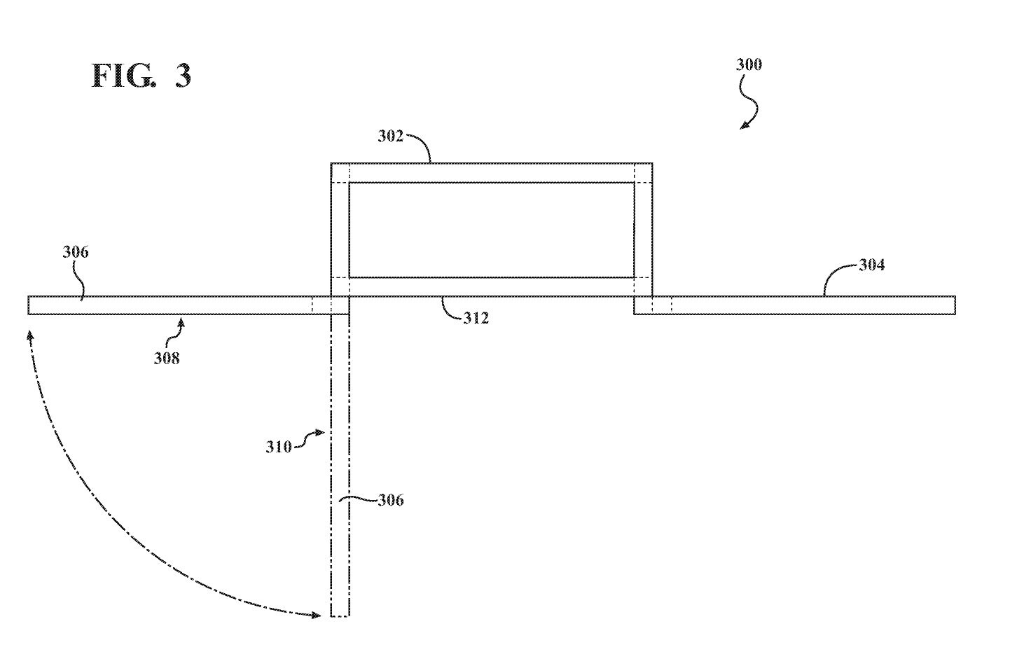

FIG. 3 is a top view of the tool 300 showing the center frame 302 and the adjustability of the extended sections 304, 306. Extended section 304 is shown in a single position, aligned with a front face 312 of the center frame 302. Extended section 306 is shown in two different positions. A first position of extended section 308 is aligned with the front face 312 of the center frame 302, similar to extended section 306. Extended section 306 is also shown in a second position 310, rotated 180 degrees to a position perpendicular to the front face 312 of the center frame 302. The range of motion of 180 degrees applies to both extended sections 304, 306 and any position in between 0 and 180 degrees is possible for each extended section 304, 306 independently of each other. Ultimately, the position in which each of the extended sections 304, 306 are set to during evaluations or testing may be determined based on several factors, including, but not limited to the vehicle being testing, the test/evaluation being administered, and the environment the testing/evaluation is being conducted.

Referring again to FIG. 1, the tool 100 has a plurality of supports, such as shelves 114. The shelves are capable of holding or storing a variety of equipment that may be used during evaluation. For example, a computer or other processor may be used to collect, store, analyze data and output test results. Loudspeakers, amplifiers, microphones, etc. may also be used. The tool 100 may be made from extruded aluminum and affixed to a motorcycle stand. The motorcycle stand may be custom or commercially available. The tool 100 provides a foundation for creating a repeatable quality control process for subjectively evaluating the sound quality of an audio system for an open-air vehicle.

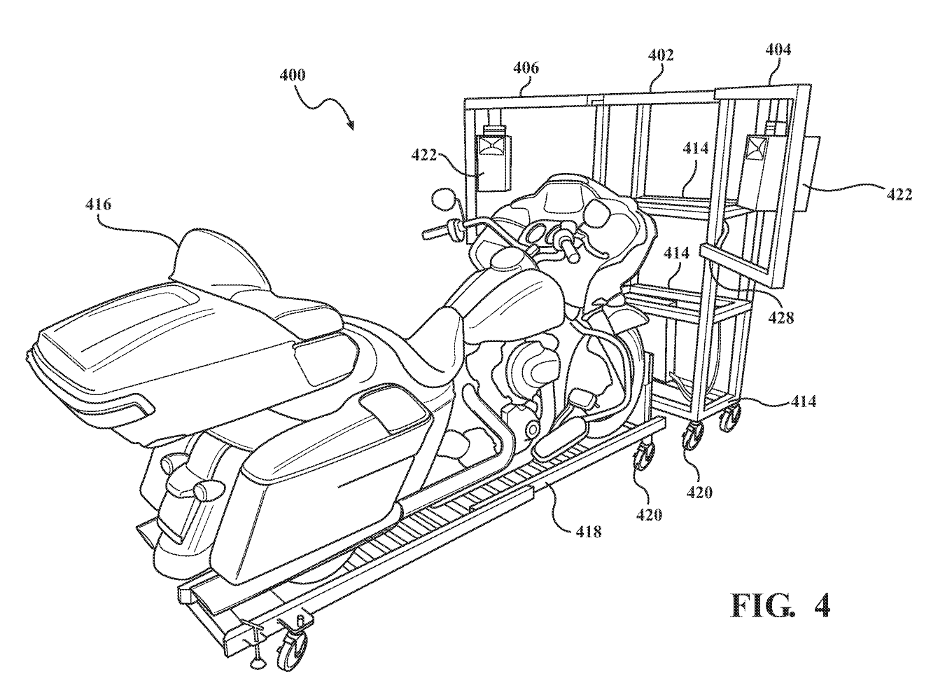

As shown in FIG. 3, the extended sections 304, 306 are also framed to hold or support equipment that may be used during testing and evaluations. FIG. 4 shows a perspective view of the tool 400 as it may be used to evaluate or test an audio system for an open-air vehicle 416, such as the motorcycle shown in FIG. 4. The motorcycle 416 is on a stand 418. In the example shown in FIG. 4, the stand 418 and the tool 402 are on casters 420. The casters 420 allow the tool and/or the motorcycle stand to be wheeled or moved from one location to another for various testing and evaluation scenarios. For example, a particular evaluation arrangement associated with the tool 402 may be set and a different motorcycle 418 may be wheeled into position. Alternatively, a particular motorcycle 418 may remain in position while a tool 402 having a different testing/evaluation arrangement may be wheeled into position. Yet another example is having the motorcycle stand 418 attached to the center frame 402 so that the entire assembly may be easily moved about or repositioned within a testing/evaluation environment from one location to another. Transducers 428 are attached to the extended sections 404, 406. Because the extended sections 304, 306 are adjustable, various ellipse points may be created.

Additionally, the configuration of the tool 402 is modular and may include more or fewer shelves 414, adaptable framework, coasters, tracks, connectors, and/or variations of equipment than what is shown in FIG. 4. The flexibility to setup, arrange, and store acoustical testing gear is advantageous in that the amount, type and arrangement of equipment may also be easily modified. For example, FIG. 4 has loudspeakers 422 suspended from the extended sections 404, 406. The position of the loudspeaker mounted within each extended section itself may be modified from what is shown in FIG. 4. For example, the loudspeakers 422 are shown to be positioned at the top, outside areas of the extended sections. There are numerous different arrangements that may be configured. For example, the loudspeakers may be easily adjusted to top, inside areas of the extended sections. Or they may be positioned at the bottom of the extended sections, in the middle, outer or inner edges of the extended sections. More than one loudspeaker in each section may also be used. One skilled in the art is capable of determining unlimited configurations that are possible using the tool 400 described herein.

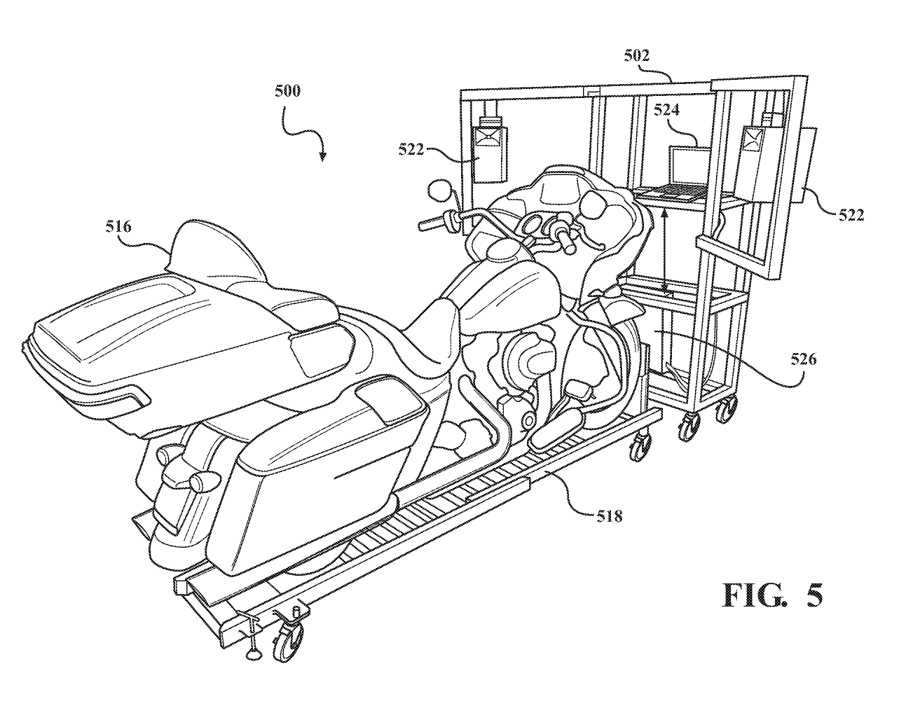

FIG. 5 is a block diagram of a system 500 for acoustical testing of an open-air vehicle. The system 500 includes a tool 502 for holding test equipment, including but not limited to a computer or processor 524, testing equipment such as at least one loudspeaker 522 and at least one amplifier 526, a test subject 516 and a stand 518 to support the test subject 516. An example application of the system 500 would be to arrange the test equipment as desired, including the open-air vehicle 516. Run one or more evaluations or tests and collect data to be analyzed as desired.

In the foregoing specification, the inventive subject matter has been described with reference to specific exemplary embodiments. Various modifications and changes may be made, however, without departing from the scope of the inventive subject matter as set forth in the claims. The specification and figures are illustrative, rather than restrictive, and modifications are intended to be included within the scope of the inventive subject matter. Accordingly, the scope of the inventive subject matter should be determined by the claims and their legal equivalents rather than by merely the examples described.

For example, the steps recited in any method or process claims may be executed in any order and are not limited to the specific order presented in the claims. The components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the inventive subject matter, in addition to those not specifically recited, may be varied or otherwise particularly adapted to specific environments, manufacturing specifications, design parameters or other operating requirements without departing from the general principles of the same.

1. A reference tool for evaluating an audio system on an open-air vehicle, the tool comprising:
a center frame;
a first adjustable section extending laterally from a first side of the center frame;
a second adjustable section extending laterally from a second side of the center frame;
at least one piece of test equipment supported by the center frame, the first adjustable section or the second adjustable section; and
the first and second adjustable sections being positioned to define an acoustic reference for the reference tool.

2. The reference tool as claimed in claim 1 wherein the first and second adjustable sections each have a range of motion between 0 and 180 degrees to a position perpendicular to the center frame and the first and second adjustable sections may be positioned independently of each other.

3. The reference tool as claimed in claim 1 wherein the position of the first and second adjustable sections relative to the center frame is determined based on one or more of: the vehicle being evaluated, a test being administered using the at least one piece of test equipment, or an environment in which the test is being administered.

4. The reference tool as claimed in claim 1 further comprising a plurality of supports selected from the list consisting of: shelves, coasters, tracks, connectors, and adaptable framework, and wherein the plurality of supports are positioned in one or more of the center frame, the first adjustable section and the second adjustable section to position at least one piece of test equipment.

5. The reference tool as claimed in claim 1 further comprising a processor communicatively coupled to the piece of test equipment to collect and analyze data within the acoustic reference.

6. The reference tool as claimed in claim 1 further comprising a stand for the open-air vehicle positioned in front of the center frame.

7. The reference tool as claimed in claim 6 wherein the stand is connected to the center frame.

8. A modular apparatus for defining an acoustic reference, the system comprising:
a center frame;
a first side frame extending laterally from a first side of the center frame and adjustable between 0 and 180 degrees with respect to the center frame;
a second side frame extending laterally from a second side of the center frame and adjustable between 0 and 180 degrees; and
at least one piece of test equipment mounted to at least one of the center, first side or second side frames thereby defining the acoustic reference.

9. The apparatus as claimed in claim 8 wherein the center, first side and second side frames further comprise adjustable supports to hold and position the at least one piece of test equipment to further define the acoustic reference.

10. The apparatus as claimed in claim 8 wherein the at least one piece of test equipment further comprises at least one of a computer, processor, transducer, loudspeaker, amplifier, microphone.

11. The apparatus as claimed in claim 8 further comprising a stand positioned with respect to the center frame.

12. The apparatus as claimed in claim 11 wherein the stand is fixed to the center frame.

13. A method for evaluating an audio system on an open-air vehicle, the method comprising the steps of:
setting a position of a center frame relative to the open-air vehicle;
adjusting a position of a first side frame that extends laterally from a first side of the center frame;
adjusting a position of a second side frame that extends laterally from a second side of the center frame;
positioning a plurality of supports on the center, first side and second side frames to support at least one piece of test equipment and define an acoustic reference for the audio system; and
collecting data from the at least one piece of test equipment.

14. The method as claimed in claim 13 wherein the step of positioning a plurality of adjustable supports further comprises positioning one or more shelves, adaptable framework, coasters, tracks, and connectors on the frames in predetermined locations.

15. The method as claimed in claim 13 wherein the step of collecting data further comprises collecting data from at least one of transducers, loudspeakers, amplifiers, computers, processors, and microphones supported on the frames.
